(19) United States
(12) Patent Application Publication
(10) Pub. No.: US 2017/0105552 A1
(43) Pub. Date: Apr. 20, 2017

(54) ROTATABLE DISPLAY

(71) Applicant: The Unicover Corporation, Cheyenne, WY (US)

(72) Inventors: Larry Schoeler, Cheyenne, WY (US); Cheryl Mefford, Cheyenne, WY (US)

(21) Appl. No.: 15/367,844

(22) Filed: Dec. 2, 2016

Related U.S. Application Data
(63) Continuation of application No. 14/327,848, filed on Jul. 10, 2014, now Pat. No. 9,532,668.

(51) Int. Cl. A47G 1/12; B65D 25/54; G07D 9/00; B65D 73/00; B65D 85/58; A47F 7/00; B65D 25/10; B65D 43/02

(52) U.S. Cl. CPC A47G 1/12; B65D 25/10; B65D 25/54; B65D 43/02; B65D 73/0035; B65D 85/58; A47F 7/0042; G07D 9/004

(57) ABSTRACT

A rotatable display for containing an article including a coin. The rotatable display can include an article receptacle for holding the article, which can be easily rotated by a user. The article receptacle can have an outer flange. A display panel can rotatably capture the article receptacle. The display panel can include a first display layer and an annular retaining structure mounted to the first display layer rotatably capturing the outer flange of the article receptacle against the first display layer. The annular retaining structure can be deflectable against the outer flange. The annular retaining structure can have a smooth slippery surface, and can be configured for deflecting away from the first display layer and to facilitate rotation of the outer flange and the article receptacle relative to the display panel.

### RELATED APPLICATION(S)

This application is a continuation of U.S. application Ser. No. 14/327,848, filed Jul. 10, 2014. The entire teachings of the above application are incorporated herein by reference.

### BACKGROUND

Coin collection displays that have sealed rotatable coin bubbles or capsules within a paperboard display can allow the coin bubble to be rotated relative to the display to align the coins for desired viewing. A drawback of such sealed rotatable coin bubbles is that the coin bubbles do not allow for the removal and replacement of coins without destroying the display or bubbles. In addition, other current coin collection displays that allow for the removal of a coin, do not allow for rotation and preferred alignment of the coin without opening the protective capsule. This is something that some coin collectors prefer not to do.

### SUMMARY

The present invention can provide a display that can allow both full rotation of stored articles or coins, as well as their removal and replacement. Embodiments of the present invention can provide a rotatable display for containing an article including a coin, which can be easily rotated by a user. The rotatable display can include an article receptacle for holding the article. The article receptacle can have an outer flange. A display panel can rotatably capture the article receptacle. The display panel can include a first display layer and an annular retaining structure mounted to the first display layer rotatably capturing the outer flange of the article receptacle against the first display layer. The annular retaining structure can be deflectable against the outer flange, including annularly defectable. The annular retaining structure can have a smooth slippery surface, and can be configured for deflecting away from the first display layer and to facilitate, or permit easier rotation of the outer flange and the article receptacle relative to the display panel.

In particular embodiments, the annular retaining structure can include a flat annular plastic washer having a thickness that is thin enough to resiliently deflect in an annular manner concentrically around an inner diameter. The display panel can further include a second display layer adhered to the first display layer. The second display layer can have a hole formed therein to form a pocket that accepts the outer flange of the article receptacle. The annular retaining structure can be mounted to the second display layer in a manner to form an annular cantilevered inner lip for annularly deflecting against the outer flange of the article receptacle. The display panel can further include a third display layer adhered over the second display layer and outer perimeter portions of the annular retaining structure. The third display layer can have a hole formed therein to further form the pocket, and can be sized to permit annular deflection of the annular cantilevered inner lip of the annular retaining structure. The display panel can further include a fourth display layer adhered over the third display layer. The fourth display layer can have a hole formed therein for closely fitting around the article receptacle and can substantially cover from view the pocket and annular retaining structure.

The first, second, third and fourth display layers can be formed of paperboard. In some embodiments, the paperboard layers can be about 0.010-0.018 inches thick, the outer flange of the article receptacle can be about 0.03-0.1 inches thick, and the annular retaining structure can be formed of PETG plastic about 0.004-0.009 inches thick. The article receptacle can be formed of a base, and a lid that is removably securable to the base. The base can have a cavity surrounded by the outer flange. The lid can be securable over the cavity. The annular retaining structure can be capturable between the outer flange of the base and the lid. The display panel can be configured for rotatably capturing more than one article receptacle.

The present invention can also provide a rotatable display for an article including an article receptacle for holding the article. The article receptacle can have a base, and a lid that is removably securable to the base. The base can have a cavity surrounded by an outer flange. A display panel can rotatably capture the article receptacle. The display panel can include paperboard layers forming a pocket for receiving the outer flange of the article receptacle, and a flat annular plastic washer rotatably capturing the outer flange against a first paperboard layer. The washer can be deflectable against the outer flange by an annular cantilevered inner lip, including annularly deflectable. The annular cantilevered inner lip of the washer can also be capturable between the outer flange of the base and the lid of the article receptacle. The washer can have a smooth slippery surface and can be configured for deflecting away from the first paperboard layer and to facilitate, or permit easier rotation of the outer flange and the article receptacle relative to the display panel.

The present invention can also provide a method of displaying an article including holding the article within an article receptacle. The article receptacle can have an outer flange. The article receptacle can be rotatably captured with a display panel. The display panel can include a first display layer and an annular retaining structure mounted to the first display layer rotatably capturing the outer flange of the article receptacle against the first display layer. The annular retaining structure can be deflectable against the outer flange, including annularly deflectable. The annular retaining structure can have a smooth slippery surface, and can be configured for deflecting away from the first display layer and to facilitate, or permit easier rotation of the outer flange and the article receptacle relative to the display panel.

In particular embodiments, the annular retaining structure can be provided as a flat annular plastic washer having a thickness that is thin enough to resiliently deflect in an annular manner concentrically around an inner diameter. The display panel can be provided with a second display layer adhered to the first display layer. The second display layer can have a hole formed therein to form a pocket that accepts the outer flange of the article receptacle. The annular retaining structure can be mounted to the second display layer in a manner to form an annular cantilevered inner lip for annularly deflecting against the outer flange of the article receptacle. The display panel can be provided with a third display layer adhered over the second display layer and outer perimeter portions of the annular retaining structure. The third display layer can have a hole formed therein to further form the pocket, and can be sized to permit annular deflection of the annual cantilevered inner lip of the annular retaining structure. The display panel can be provided with a fourth display layer adhered over the third display layer. The fourth display layer can have a hole formed therein for closely fitting around the article receptacle and substantially covering from view the pocket and annular retaining structure.

The first, second, third and fourth display layers can be provided as paperboard layers. In some embodiments, the paperboard layers can be provided with a thickness of about 0.010-0.018 inches thick, the outer flange of the article receptacle can be provided with a thickness about 0.03-0.1 inches thick, and the annular retaining structure can be formed of PETG plastic and about 0.004-0.009 inches thick. The article receptacle can be provided with a base, and a lid that is removably securable to the base. The base can have a cavity surrounded by the outer flange. The lid can be securable over the cavity. The annular retaining structure can be capturable between the outer flange of the base and lid. More than one article receptacle can be rotatably captured with the display panel.

The present invention can also provide a method of displaying an article including holding the article in an article receptacle. The article receptacle can have a base, and a lid that is removably securable to the base. The base can have a cavity surrounded by an outer flange. The article receptacle can be rotatably captured with a display panel. The display panel can include paperboard layers forming a pocket for receiving the outer flange of the article receptacle, and a flat annular plastic washer rotatably capturing the outer flange against a first paperboard layer. The washer can be deflectable against the outer flange by an annular cantilevered inner lip, including annularly deflectable. The annular cantilevered inner lip of the washer can also be capturable between the outer flange of the base and the lid of the article receptacle. The washer can have a smooth slippery surface, and can be configured for deflecting away from the first paperboard layer and to facilitate, or permit easier rotation of the outer flange and the article receptacle relative to the display panel.

### BRIEF DESCRIPTION OF THE DRAWINGS

FIG. 1 is a schematic plan view of an embodiment of a rotatable display in the present invention.

FIG. 2 is a side sectional view of an embodiment of an article receptacle.

FIG. 3 is a side sectional view of a portion of the rotatable display of FIG. 1.

FIG. 4 is a side sectional view enlargement of a portion of FIG. 3.

FIG. 5 is a plan view of an embodiment of an annular retaining structure.

FIG. 6 is a side sectional view of an annular retaining structure deflecting against the outer flange of the article receptacle in an embodiment of the present invention.

FIG. 7 is a plan view of another embodiment of a rotatable display in the present invention.

FIG. 8 is a perspective view of yet another embodiment of a rotatable display in the present invention.

### DETAILED DESCRIPTION

A description of example embodiments of the invention follows.

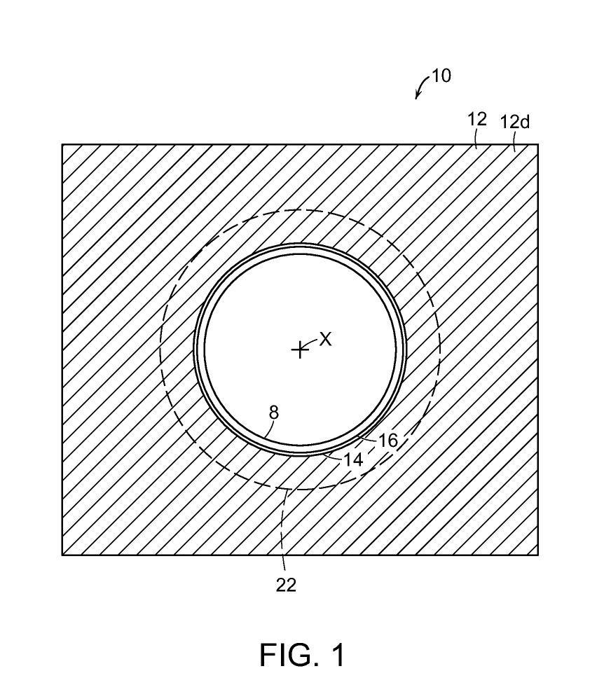

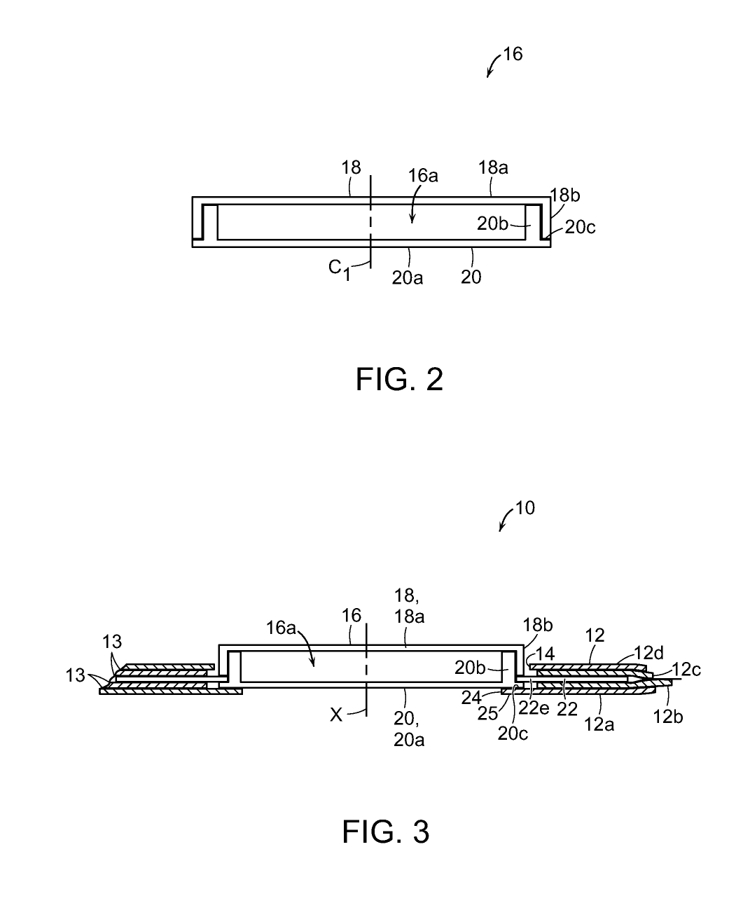

Referring to FIGS. 1-4, in one embodiment of the present invention, rotatable display 10 can include a display card, structure, sheet or panel 12, to which one or more article capsules, bubbles, containers, or receptacles 16, are rotatably mounted about a central axis X, for containing and displaying articles 8, such as coins, medallions, medals, or other desired collectible articles. An article 8 contained within a receptacle 16, can be oriented into a proper or desired viewing orientation by rotating the receptacle 16 relative to the display panel 12.

The receptacle 16 can be formed of a clear polymer or plastic, such as acrylic, or other suitable clear plastic, for allowing viewing of two sides of an article 8, such as a coin. The receptacle 16 can be round or circular, and can be formed of two pieces, a first, back or rear portion or base 20, and a second, top, front, forward or lid portion 18, which can be removably secured or snapped together. This can allow the insertion and removal of articles 8 into and from the cavity, hollow, cup, bowl, recess or space 16a within the receptacle 16. The base 20 can have a flat circular or round back or rear wall 20a, a circular, round or annular side wall 20b extending forwardly from the back wall 20a, and a circular, round or annular outer lip, shoulder or flange 20c concentrically surrounding the side wall 20b. The outer flange 20c can be a continuation along the plane of the back wall 20a, and extend radially outward from the side wall 20b. The lid 18 can have a flat circular or round top, front, forward or lid wall 18a, and a circular, round or annular side wall 18b extending rearwardly from wall 18a for removably engaging, securing or snapping over the side wall 20b of the base 20, for removable securement. The base 20 and the lid 18, along with their respective structures 20a, 20b, 20c and 18a and 18b, can be centered or concentric about a central axis C₁.

The display panel 12 can be formed of multiple layers of panels or sheets, such as paperboard. For example, the display panel 12 can have a first, back, rear or outer paperboard display layer 12a with a second or inner paperboard display layer 12b, secured, bonded or adhered to the paperboard layer 12a, such as by a first adhesive layer 13. A third or additional inner paperboard display layer 12c can be secured, bonded or adhered to paperboard layer 12b, such as by a second adhesive layer 13. A fourth, front or outer paperboard display layer 12d can be secured, bonded or adhered to the paperboard layer 12c, such as by a third adhesive layer 13. In some embodiments, the paperboard layers 12a-12d can be bonded together under heat and pressure, or by heat sealing. In other embodiments, cold glue or adhesive can be used, and can include adhesive coated tapes or films. In some embodiments, combinations of heat and cold sealing or adhesive processes can be used.

The outer front and back paperboard layers 12a and 12d can have graphics printed thereon, as well as protective films, coatings or layers, including UV coatings. The back paperboard layer 12a can have a window, aperture, opening or hole 24 concentric with axis X for viewing the rear or back side of the article 8 within receptacle 16. Holes, apertures or openings 28 and 26 can be formed within respective inner paperboard layers 12b and 12c concentric with axis X to form a recess, space, cavity or pocket 30 within panel display 12 for rotatably mounting, receiving or containing receptacle 16. A circular, round or annular retaining structure or member 22, such as a thin flat circular, round or annular resilient, flexible, bendable, elastic, deformable or deflectable plastic washer, bearing or spring, having an outer periphery or diameter 22a and an inner periphery or diameter hole 22b, concentric about a central axis C₂, can be bonded, adhered or secured between the two inner paperboard layers 12b and 12c, such as by adhesive layers 13, concentric with axis X. The washer 22 can resiliently rotatably retain the receptacle 16 generally concentrically within the pocket 30, by resiliently engaging, trapping or capturing the outer flange 20c of the base 20 of the receptacle 16. The front paperboard layer 12d can have a window, aperture, opening or hole 14 formed therein concentric with axis X, for allowing the receptacle 16 to extend there through forwardly or outwardly, allowing viewing of the front side of article 8, while at the same time substantially covering the pocket 30 and washer 22 within the display panel 12, from view of the user, for improved appearance.

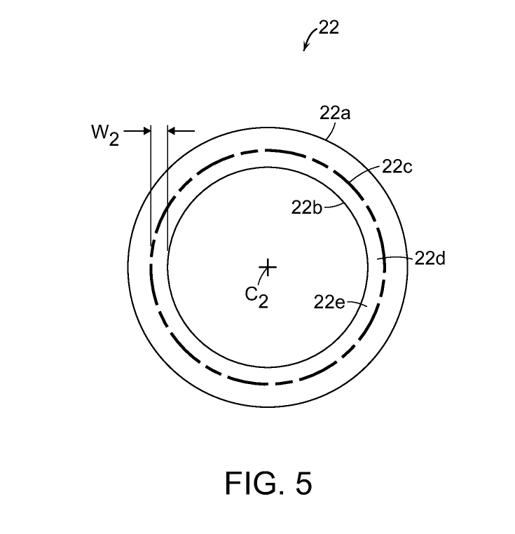

Referring to FIGS. 3-6, the flat deflectable washer 22 can be very thin, for example about 0.006 inches thick, in some embodiments. As a result, the two inner paperboard layers 12b and 12c can bulge only slightly in the transition moving from outer areas where the paperboard layers 12b and 12c are bonded directly to each other, to the inner area near receptacle 16, where the washer 22 is bonded between the paperboard layers 12b and 12c, such as at the outer diameter 22a of washer 22. The front paperboard layer 12d can hide any bulges in layers 12b and 12c on the front side, and back paperboard layer 12a can hide any bulges on the back side. The hole 24 in the back paperboard layer 12a can be sized to form a thin or narrow, round, circular or annular ring 25 of paperboard for contacting and capturing the back surface 21 of the outer flange 20c and a small portion of the back wall 20a of base 20. The thin annular ring 25 of paperboard contacting the base 20 can have a radial width W₁ about ⅛ inches wide, in some embodiments. The inner paperboard layers 12b and 12c can have respective holes 28 and 26 formed there through that are larger than hole 24 in back paperboard layer 12a, and larger than the outer flange 20c of base 20. Holes 28 and 26 are sized to allow washer 22 to extend radially inwardly from the inner edges of holes 28 and 26, a sufficient amount to form a generally lateral deflectable annular cantilevered inner lip 22e, with the inner diameter 22b engaging the sidewall 20b and the outer flange 20c of the base 20. In some embodiments, the annular cantilevered inner lip 22e can have a radial width W₂ of about ⅛ inches that can be deflectable. The annular cantilevered inner lip 22e can extend annularly radially inwardly within annular cavity 30, with cavity portion 30a being below lip 22e and cavity portion 30b being above lip 22e. The annular cantilevered inner lip 22e has sufficient space to deflect frontwardly within cavity 30 in the direction of arrow A. This can resiliently rotatably trap, capture or clamp the outer flange 20c of the base 20 between or against the annular cantilevered inner lip 22e of the washer 22 and the annular ring 25 of paperboard of the back paperboard layer 12a. The inner diameter 22b of the washer 22 is sized to closely engage or capture the sidewall 20b of the base 20 to prevent lateral movement so that the center axis C₁ of the base 20 and receptacle 16 can be concentrically rotated about the central axis X and the center axis of washer C₂. The outer flange 20c of the base 20 can have back 21 and front 23 opposed surfaces for contacting the annular ring 25 of paperboard of the back paperboard layer 12a, and the annular cantilevered inner lip 22e of the washer 22. The surfaces 21 and 23 of the outer flange 20c can be smooth and slippery for facilitating rotation. The annular ring 25 of paperboard that contacts outer flange 20c can have a slippery coating formed thereon for forming a bearing surface. When the lid 18 is secured to the base 20, the sidewall 18b of the lid 18 can engage the front surface of the annular cantilevered inner lip 22e of the washer 22, axially trapping or capturing the lip 22e between the outer flange 20c of the base 20 and the sidewall 18b of the lid 18. However, the surface of the sidewall 18b contacting the lip 22e, as well as the surfaces of the lip 22e or outer flange 20c can be smooth and slippery, so that rotation of the receptacle 16 about axis X while being laterally and axially retained by the washer 22 and annular ring 25 of back paperboard layer 12a can be achieved.

The smooth slippery nature of the annular cantilevered inner lip 22e and the washer 22, as well as the ability of the lip 22e to axially deflect frontwardly concentrically around axis X in the direction of arrow A, can allow the receptacle 16 to rotate more easily than if the receptacle 16 were tightly rotatably held in place with paperboard layers. The washer 22 can provide a smooth slippery bearing surface for rotation of receptacle 16, in both the radial and thrust directions relative to axis X via inner diameter 22b and flat opposed surfaces 22d. The washer 22 can form a barrier to the adhesives used in bonding the paperboard layers 12a-12d, from contacting the outer flange 20c of the base 20, which could interfere with rotational ability. The washer 22 and its inner diameter 22b can be sized to prevent contact of the outer flange 20c of the base 20 and receptacle 16 with paperboard layers 12b-12d, including with holes 28, 26 and 14. The annular cantilevered inner lip 22e of the washer 22 can resiliently deflect forwardly in the direction of arrow A away from back paperboard layer 12a when the receptacle 16 is rotated, which can move the outer flange 20c and base 20 away from the annular ring 25 of the back paperboard layer 12a, and reduce the axial pressure or force that the outer flange 20c and the base 20 exerts on the annular ring 25 of the back paperboard layer 12a, which can reduce the friction force between the outer flange 20c and the back paperboard layer 12a. For example, grasping the receptacle 16 between two fingers and pushing the receptacle 16 frontward in the direction of arrow A while rotating, makes the receptacle 16 easier to rotate due to decreased friction of the outer flange 20c with back paperboard layer 12a. In contrast, pushing the receptacle 16 backward against the back paperboard layer 12a when rotating typically increases friction of the base 20 with the back paperboard layer 12a and makes the receptacle 16 more difficult to rotate. One does not need to push the receptacle 16 frontward while rotating to obtain easier rotation in comparison with a prior art capsule that is tightly held by paperboard layers. The washer 22 can be configured to normally exert lower axial pressure or friction force on the outer flange 20c, while capturing flange 20c, than in such prior art, and rotation of receptacle 16 is easier. In some embodiments, rotation of receptacle 16 can be easier then such prior art without requiring deflection of washer 22. In some embodiments, deflection of the washer 22 can be very small and virtually un-noticeable, while providing desired rotational benefits. In some embodiments, the inner paperboard layer 12b can have the same thickness as outer flange 20c, so that at rest, washer 22 can be in an undeflected state.

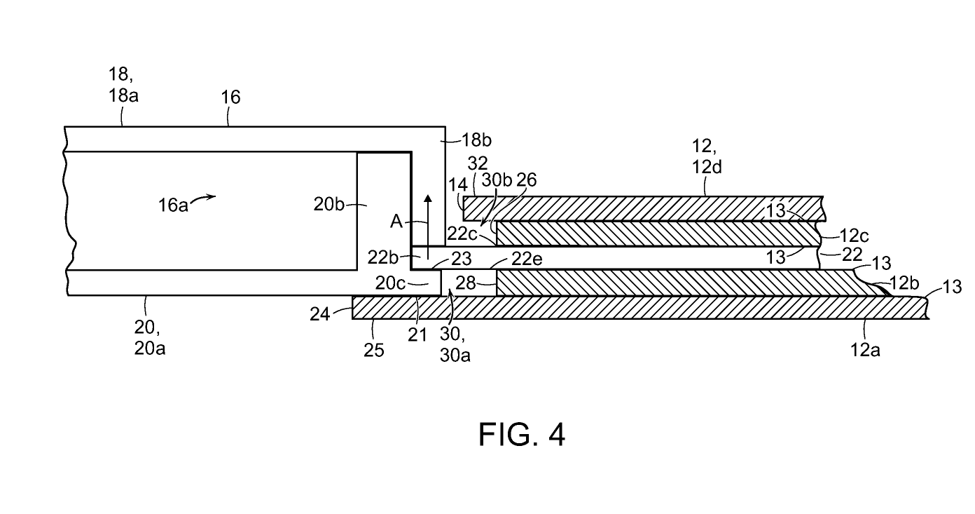

As seen in FIGS. 4-6, the annular cantilevered inner lip 22e can annularly deflect along an annular, round or circular deflection line 22c which generally corresponds or relates to the diameter or periphery of cavity 30, formed by the diameter of holes 28 and 26 of inner paperboard layers 12b and 12c. The washer 22 can be trapped between the two inner paperboard layers 12b and 12c, and the edges of the holes 28 and 26 can provide an annular, round or circular pivot point or edge about which the lip 22e can annularly resiliently deform, deflect or bend. The cavity 30 can not only provide space for rotatably moving or mounting the receptacle 16, but also serves as a deflection cavity for allowing deflection of the lip 22e frontwardly in the direction of arrow A concentrically about axis X. The front paperboard layer 12d can have an annular or circular lip 32 in part formed by hole 14, extending concentrically radially inwardly over cavity 30 a substantial amount which can form a physical or mechanical stop for engaging the lip 22e when deflected frontwardly in the direction A, and stopping or preventing further frontward movement. This can prevent the outer flange 20c of the receptacle 16 from pulling, deflecting and deforming the lip 22e too far forwardly in the direction of arrow A, and can prevent the outer flange 20c and receptacle 16 from disengaging from lip 22e. Hole 14 can provide a large enough annular space or gap around the side wall 18b of the lid 18 of the receptacle 16 to allow the insertion of a fingernail for removing the lid 18, and to minimize substrate damage to at least paperboard layer 12d. In some embodiments, the space can range about 0.03-0.05 inches wide.

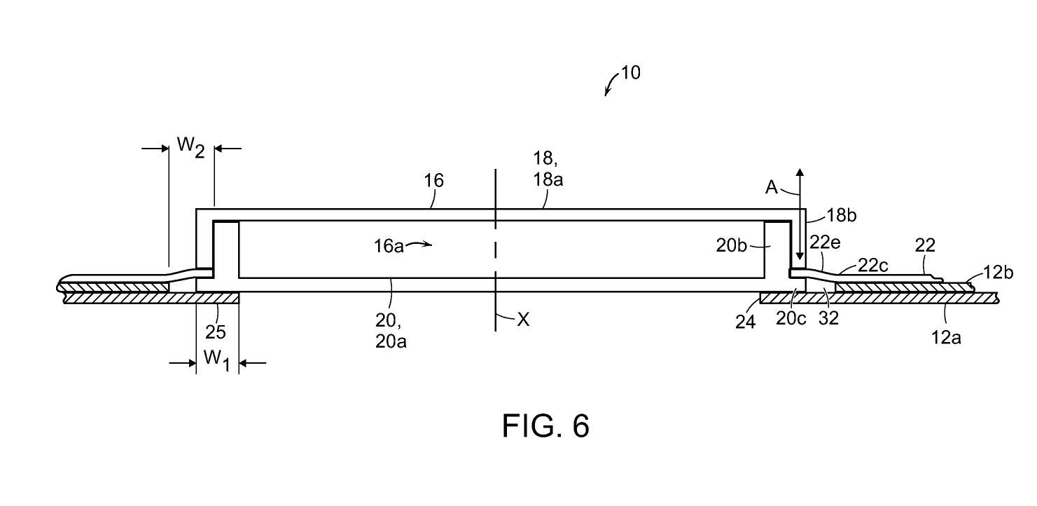

Referring to FIG. 6, in some embodiments, the outer flange 20c of the base 20 can be thicker than the adjacent inner paperboard layer 12b, so that the washer 22 is initially resiliently deflected when assembled with the base 20 to provide an initial preload bias against the front of the outer flange 20c, resiliently trapping, clamping or pressing the outer flange 20c against the annular ring 25 of the back paperboard layer 12a. This can prevent or reduce unwanted movement of the receptacles 16, either rotationally or in the direction of arrow A, relative to display panel 12, and can prevent or reduce unwanted rattling of the receptacles 16.

In one embodiment, the paperboard layers 12a-12d can be about 0.015 inches thick, and the outer flange 20c of base 20 can be about 0.05 inches thick, to provide an initial preload bias from washer 22 against outer flange 20c. The outer flange 20c can have a radial width of about 0.045 inches but can vary, for example between 0.030-0.060 inches. In other embodiments, the thickness of the layers of paperboard 12a-12d can vary for example from about 0.010-012 inches to about 0.016-0.018 inches, or even up to 0.03 inches. If desired, at least some of the paperboard layers can be impregnated with adhesive, such as on inner or internal joined surfaces of the display panel 12. In addition, the outer flange 20c can have a thickness from about 0.03-0.04 inches to about 0.06-0.08 inches or about 0.09 to 0.1 inches. The washer 22 can be formed of polyethylene terephthalate glycol (PETG) and can have a thickness of about 0.004-0.005 inches to about 0.007-0.009 inches. In some embodiments, the washer 22 can be formed of other suitable materials such as suitable plastics, metals, composites, etc. The receptacle 16 can be formed of acrylic, but can be formed of other suitable plastics or materials including polyethylene terephthalate glycol (PETG). The receptacle 16 can be a variety of sizes for holding various sizes of articles and such as coins or medallions. For example, the outer periphery dimensions of a receptacle 16 for holding a silver dollar can be about 1¾ inches. The outer 22a and inner 22b diameters of the washer 22 can vary in size depending upon the article 8 being held in the associated receptacle 16. For example, a silver dollar has a diameter of about 1½ inches, and a dime has a diameter of about 0.7 inches. For a washer 22 associated with a receptacle 16 for a silver dollar, embodiments of the washer 22 can have an inner diameter 22b around 1⅝ inches and an outer diameter 22a around 2½ inches. A washer 22 associated with a receptacle 16 for a dime would be of a smaller appropriate size. Although the radial width W₁ of the annular paperboard ring 25 of paperboard layer 12a and the radial width W₂ of the annular cantilevered inner lip 22e of the washer 22 can be about ⅛ inch, in other embodiments, widths W₁ and W₂ can vary, for example between about 1/16 to ¼ inch. Large widths W₁ of ring 25 can create more friction and make rotation more difficult. Widths W₂ of annular cantilevered inner lip 22e of washer 22 that are too small, might not deflect easily and can also make rotation more difficult. In some embodiments, some or all of the paperboard layers 12a-12d can be replaced with layers or sheets of other materials, such as with plastics, composites, wood products, metals, foils, etc.

During manufacturing, the base 20 of the receptacle 16 can be assembled with the display panel 12, and sealed under heat and pressure, or by other suitable methods, and the lids 18 can be assembled after sealing. The articles 8, such as coins can be installed later, for example by the manufacturer, or customer. The removable lid 18 allows the receptacles 16 to be opened for inspecting, removing and/or replacing the articles 8 contained therein. The four layers 12a-12d of paperboard can provide rigidity to the display panel 12 which not only is desirable for appearances, but can allow the washer 22 to operate in a predictable manner. The inner paperboard layers 12b and 12c can be adhesive impregnated in advance, or adhesive can be applied at assembly.

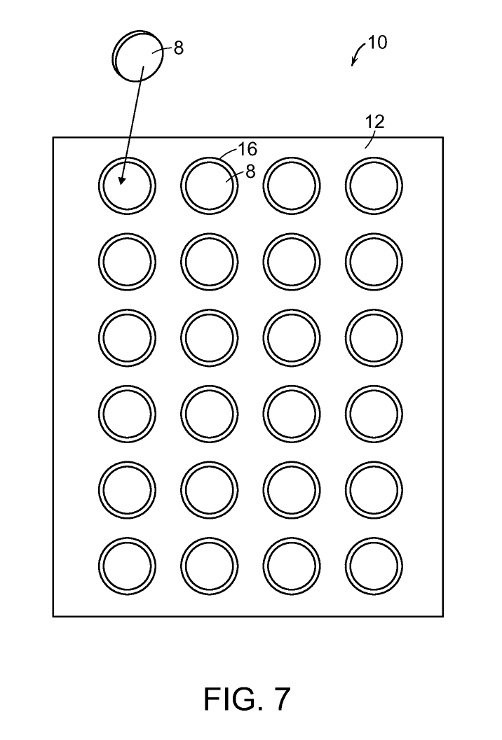

Referring to FIG. 7, embodiments of the rotatable display 10 can include a display panel 12 containing more than one or multiple rotatable receptacles 16. Although the receptacles 16 are shown to be of the same size, the sizes of the receptacles 16 can also vary, for example, to display pennies, dimes, nickels, quarters, half dollars, dollars, etc. on the same rotatable display 10. A large number of receptacles 16 such as shown in FIG. 7 can be on a large display panel 12. Smaller display panels 12 can have smaller numbers of receptacles 16. In a display panel 12 that is 8½×11 inches, the receptacles 16 can be in a 3×4 configuration to provide sufficient room between receptacles 16 to accommodate the size of the washers 22.

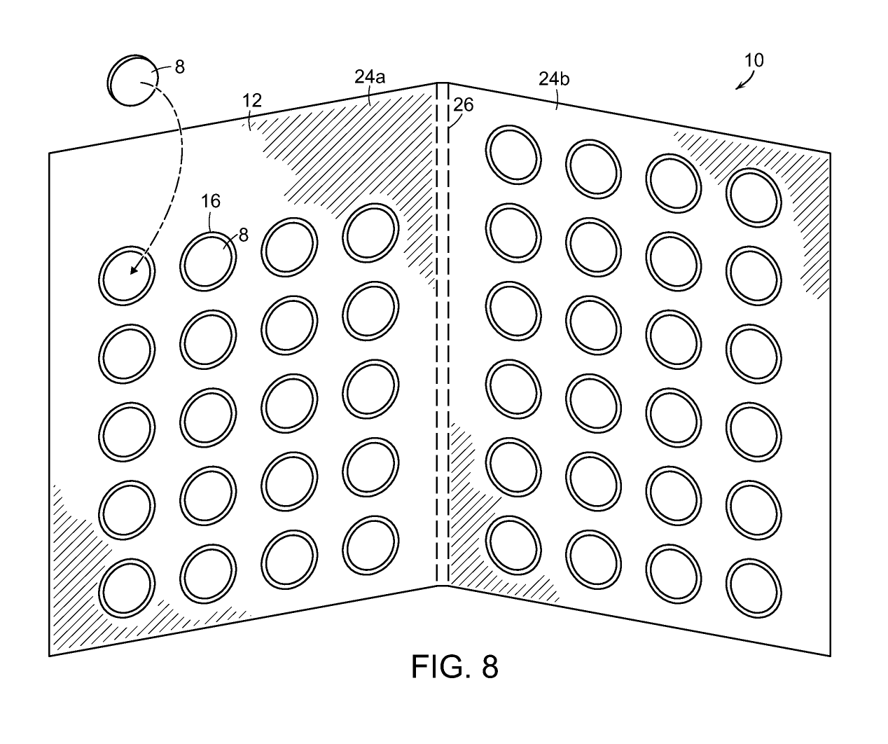

Referring to FIG. 8, embodiments of the rotatable display 10 can include a display panel 12 having at least two foldable leaves, panels or pages 24a and 24b, foldably connected together by a fold line 26. Although leaves 24a and 24b are both shown to include multiple receptacles 16, the number of receptacles 16 on each leaf can vary, and one leaf might not have any receptacles 16.

While this invention has been particularly shown and described with references to example embodiments thereof, it will be understood by those skilled in the art that various changes in form and details may be made therein without departing from the scope of the invention encompassed by the appended claims.

It is understood that various features described or shown can be omitted or combined together. Although particular dimensions have been given, it is understood that dimensions can vary, depending upon the situation at hand. In addition, although directional terms have been used, such as front, back, etc., it is understood that this does not limit the orientation of the rotatable display 10 or its elements. It is also understood that the receptacles 16 do not have to be round, but can have other suitable shapes for containing desired articles. Archival quality materials can be used for the components of the present invention, but comparable materials can be used in some embodiments if archival quality is not a requirement for containment of articles 8.

What is claimed is:

1. A method of displaying an article comprising:
holding the article within an article receptacle, the article receptacle having an outer flange; and
rotatably capturing the article receptacle with a display panel, the display panel comprising a first display layer and an annular retaining structure mounted to the first display layer rotatably capturing the outer flange of the article receptacle against the first display layer, the annular retaining structure being deflectable against the outer flange, the annular retaining structure having a smooth slippery surface and configured for deflecting away from the first display layer and to facilitate rotation of the outer flange and the article receptacle relative to the display panel.

2. The method of claim 1 further comprising providing the annular retaining structure as a flat annular plastic washer having a thickness that is thin enough to resiliently deflect in an annular manner concentrically around an inner diameter.

3. The method of claim 2 further comprising providing the display panel with a second display layer adhered to the first display layer, the second display layer having a hole formed therein to form a pocket that accepts the outer flange of the article receptacle, the annular retaining structure being mounted to the second display layer in a manner to form an annular cantilevered inner lip for annularly deflecting against the outer flange of the article receptacle.

4. The method of claim 3 further comprising providing the display panel with a third display layer adhered over the second display layer and outer perimeter portions of the annular retaining structure, the third display layer having a hole formed therein to further form the pocket, and sized to permit annular deflection of the annular cantilevered inner lip of the annular retaining structure.

5. The method of claim 4 further comprising providing display panel with a fourth display layer adhered over the third display layer, the fourth display layer having a hole formed therein for closely fitting around the article receptacle and substantially covering from view said pocket and annular retaining structure.

6. The method of claim 5 further comprising providing the first, second, third and fourth display layers as paperboard layers. The method of claim 6 further comprising providing the paperboard layers with a thickness about 0.010-0.018 inches thick, the outer flange of the article receptacle with a thickness about 0.03-0.1 inches thick, and the annular retaining structure being formed of PETG plastic and about 0.004-0.009 inches thick.

8. The method of claim 1 further comprising providing the article receptacle with a base, and a lid that is removably securable to the base, the base having a cavity surrounded by the outer flange, and the lid securable over the cavity, the annular retaining structure being capturable between the outer flange of the base and the lid.

9. The method of claim 1 further comprising rotatably capturing more than one article receptacle with the display panel.

10. A method of displaying an article comprising:
holding the article in an article receptacle, the article receptacle having a base, and a lid that is removably securable to the base, the base having a cavity surrounded by an outer flange; and
rotatably capturing the article receptacle with a display panel, the display panel comprising paperboard layers forming a pocket for receiving the outer flange of the article receptacle, and a flat annular plastic washer rotatably capturing the outer flange against a first paperboard layer, the washer being deflectable against the outer flange by an annular cantilevered inner lip, the annular cantilevered inner lip of the washer also being capturable between the outer flange of the base and the lid of the article receptacle, the washer having a smooth slippery surface and configured for deflecting away from the first paperboard layer and to facilitate rotation of the outer flange and the article receptacle relative to the display panel.

11. A method of forming a rotatable display for displaying an article comprising:
assembling an article receptacle with a display panel, the article receptacle for holding the article, and having an outer flange; and
rotatably capturing the article receptacle with the display panel, the display panel comprising a first display layer and a flange retaining structure mounted relative to the first display layer rotatably capturing the outer flange of the article receptacle against the first display layer within a pocket that forms a cavity spaced apart from and surrounding the outer flange, the flange retaining structure extending inwardly within the cavity to form a cantilevered lip that is deflectable against the outer flange.

12. The method of claim 11 further comprising forming the flange retaining structure as a flat annular plastic washer having a thickness that is thin enough to resiliently deflect in an annular manner concentrically around an inner diameter.

13. The method of claim 12 further comprising forming the display panel with a second display layer adhered to the first display layer, the second display layer having a hole formed therein to form the pocket that accepts the outer flange of the article receptacle, the flange retaining structure being mounted to the second display layer in a manner to form an annular cantilevered inner lip for annularly deflecting against the outer flange of the article receptacle.

14. The method of claim 13 further comprising forming the display panel with a third display layer adhered over the second display layer and outer perimeter portions of the flange retaining structure, the third display layer having a hole formed therein to further form the pocket, and sized to permit annular deflection of the annular cantilevered inner lip of the flange retaining structure.

15. The method of claim 14 further comprising forming the display panel with a fourth display layer adhered over the third display layer, the fourth display layer having a hole formed therein for closely fitting around the article receptacle and substantially covering from view said pocket and flange retaining structure.

16. The method of claim 15 further comprising forming the first, second, third and fourth display layers as paperboard layers.

17. The method of claim 16 further comprising forming the paperboard layers with a thickness about 0.010-0.018 inches thick, the outer flange of the article receptacle with a thickness about 0.03-0.1 inches thick, and the annular retaining structure being formed of PETG plastic and about 0.004-0.009 inches thick.

18. The method of claim 11 wherein the article receptacle has a base, and a lid that is removably securable to the base, the base having a cavity surrounded by the outer flange, and the lid securable over the cavity, the flange retaining structure being capturable between the outer flange of the base and the lid.

19. The method of claim 11 further comprising rotatably capturing more than one article receptacle with the display panel.
